(19) United States
(12) Patent Application Publication
(10) Pub. No.: US 2005/0044973 A1
(43) Pub. Date: Mar. 3, 2005

(54) Drive arrangement

(75) Inventor: Karlheinz Timtner, Bad Homburg v.d. Hohe (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: RINGSPANN GmbH, Bad Homburg (DE)

(21) Appl. No.: 10/903,364

(22) Filed: Jul. 30, 2004

(30) Foreign Application Priority Data
Aug. 27, 2003 (DE) 103 39 813.9

(51) Int. Cl. F16H 21/52

(52) U.S. Cl. 74/25

(57) ABSTRACT

An arrangement for driving a machine element (2), especially a sled, a tool holder, or the like, which can move at least generally in a straight line, through the use of a spiral gear, especially a threaded spindle/nut combination (3, 4) with the use of a Cardan-like or universal joint (5) with at least two joint halves (5a, 5b) is provided. The joint halves (5a, 5b) are connected to each other for exact positioning of the machine element (2) by several connecting members (25a, 25b) that are elastic in the circumferential direction but stiff in the direction of movement of the machine element.

### BACKGROUND

The invention relates to an arrangement for driving a machine element, especially a sled, a tool holder, or the like, which can move at least generally in a straight line, through the use of a spiral gear, especially a threaded spindle/nut combination with the use of a Cardan or universal joint with at least two joint halves.

In such driving arrangements, a threaded spindle or its nut is set in rotation, so that the non-rotating part experiences an axial displacement, which is transferred to the machine element. For compensating for possible errors in angle and/or alignment differences between the travel direction of the machine element on one hand and the axis of the threaded spindle/nut combination on the other hand, it is known to guide the flow of forces between the mentioned parts through one or two Cardan joints.

However, in certain applications, there is the need to guarantee a very exact correlation between the rotational position of the threaded spindle/nut combination and the corresponding position of the machine element, which can move in a straight line. A defined rotation of the threaded spindle/nut combination should thus cause the machine element to follow an exactly reproducible travel path.

For this purpose, it is already known to use recirculating ball screws, which operate without play. However, a certain inaccuracy still results from the Cardan joint, because this configuration uses four hinge points, which each feature a certain amount of play.

### SUMMARY

Starting from these conditions, the objective of the present invention is to improve the known drive to the extent that the position of the moveable machine element can be set more exactly than before, regardless of whether differences in angle and/or alignment have been equalized between the machine element and its drive. The solution according to the invention is also distinguished by a reliable and economical design.

This objective is solved according to the invention such that the mentioned joint halves are connected to each other by several connecting members that are elastic in the circumferential direction, but stiff in the moving direction of the machine element.

Thus, according to the invention the previously required four hinge points of the Cardan joint are replaced by connecting members formed integrally on both ends, so that an absolutely play-free transfer of forces is guaranteed. The desired compensation of alignment errors, assembly inaccuracies, or the like is achieved in that these connecting members are elastic in the circumferential direction but stiff in the moving direction of the machine element. Therefore, both angular and also radial displacements can be compensated, i.e., a joint according to the invention can replace two Cardan joints connected one after the other.

In principle, the connecting members can have an essentially arbitrary shape and alignment. However, it is especially favorable when the connecting members extend in the moving direction of the machine element, because then the maximum stiffness is given in this direction.

The connecting members are preferably arranged on an intermediate ring one after the other in the circumferential direction, such that they are alternately connected to one or the other joint half. The number of connecting members is arbitrary. Optimally, there are four groups of connecting members, which are distributed around the circumference offset by 90 degrees, corresponding to the four hinge points of a Cardan joint.

For the structural configuration of the connecting members, various possibilities will be understood to a person skilled in the art. According to an especially preferred refinement of the invention, the connecting members and preferably also the joint halves are formed by slots in a hollow cylinder. Simultaneously, these slots can be used to dimension the free space between the joint halves, which can move relative to each other, so that a stop against impermissibly high deformation of the connecting members is created. This will be made clear from an embodiment to be described later.

In addition, the slots can be filled at least partially with a damping mass. Therefore, resonance can be prevented and possibly disruptive resonant frequencies can be shifted into the non-critical range.

An especially favorable application of the invention is its use for the measuring of a workpiece, which is supported on a movable sled driven by a recirculating ball screw.

In principle, whether the threaded spindle or the threaded nut performs the rotation or the axial displacement is not important. For the previously described use in measuring workpieces, however, it has proven to be especially advantageous when the threaded spindle is supported on both ends fixed in the axial direction but rotatable, while the spindle nut is connected to the movable machine element via the elastically connected joint halves.

### BRIEF DESCRIPTION OF THE DRAWINGS

Further features and advantages of the invention result from the following description of an exemplary embodiment with reference to the drawing and from the drawing itself. In the drawings:

FIG. 1 is a top view of a table drive with the elastic joint according to the invention;

FIG. 2 is a diagonal view of the elastic joint;

FIG. 3 is an axial section through the joint;

FIGS. 4 and 5 are two views of an alternative construction of the invention.

### DETAILED DESCRIPTION OF THE PREFERRED EMBODIMENTS

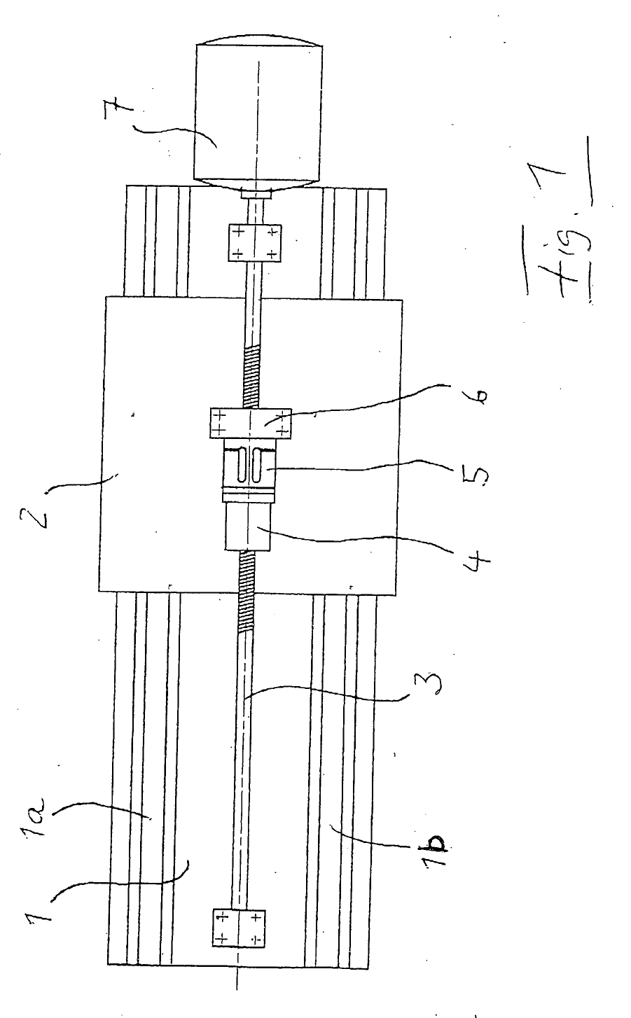

In FIG. 1, a base frame 1, which has two parallel rails 1a and 1b in the longitudinal direction, can be seen. A machine element in the form of a table 2 can be moved on these rails. The drive of the table 2 is realized by a threaded spindle 3, which is supported so that it can rotate on its two ends but cannot move in the axial direction on the base frame 1. The spindle can be set in rotation by a motor 7. It engages with a spindle nut 4, which on its side is connected to the table 2 so that it cannot rotate. The connection of the spindle nut 4 to the table 2 is realized through an elastic joint 5 according to the invention, which is connected to the table 2 by a mounting part, for example a bearing 6.

The table 2 is used for fine positioning of an object (not shown), which is mounted on the table and which is to be moved to make contact, e.g., with different tools or measurement sensors.

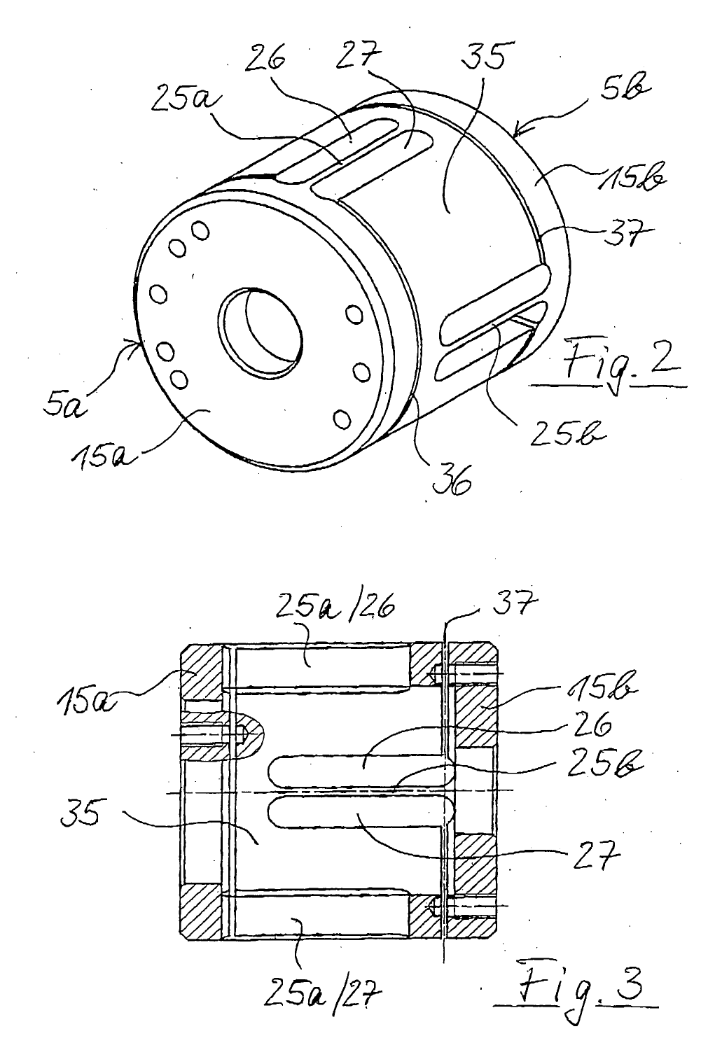

FIGS. 2 and 3 show the elastic joint in an enlarged representation. One can see that it is formed of two similar joint halves 5a and 5b. Each joint half has an annular connecting flange 15a or 15b, on which the spindle nut 4 or the bearing 6 is mounted. Several connecting members 25a or 25b, preferably two members offset by 180 degrees, extend out from each connecting flange in the axial direction towards the opposite connecting flange. These connecting members are formed as bending beams that are stiff in the axial direction but flexible in the circumferential direction and each extend into a common intermediate ring 35. Therefore, so that the connecting members 25a and 25b are arranged offset by 90 degrees over the circumference and allocated to opposing connecting flanges, the connecting flanges 15a and 15b can be bent under loading in an arbitrary direction from their parallel position in the unloaded state. One thus obtains the function of two Cardan joints, but with the elimination of any play between the joint halves.

The connecting members 25a and 25b as well as the intermediate ring 35 and the connecting flanges 15a and 15b, are preferably made from a single part, by separating the intermediate ring 35 through slots 36 and 37 running in the circumferential direction locally from its two connecting flanges and freeing the connecting members 25a and 25b through predominantly axial recesses 26 and 27 in the ring body. Thus, one obtains an economical and compact design of the complete joint. In particular, its interior remains free, so that the joint can be traversed by the threaded spindle 3 in the axial direction.

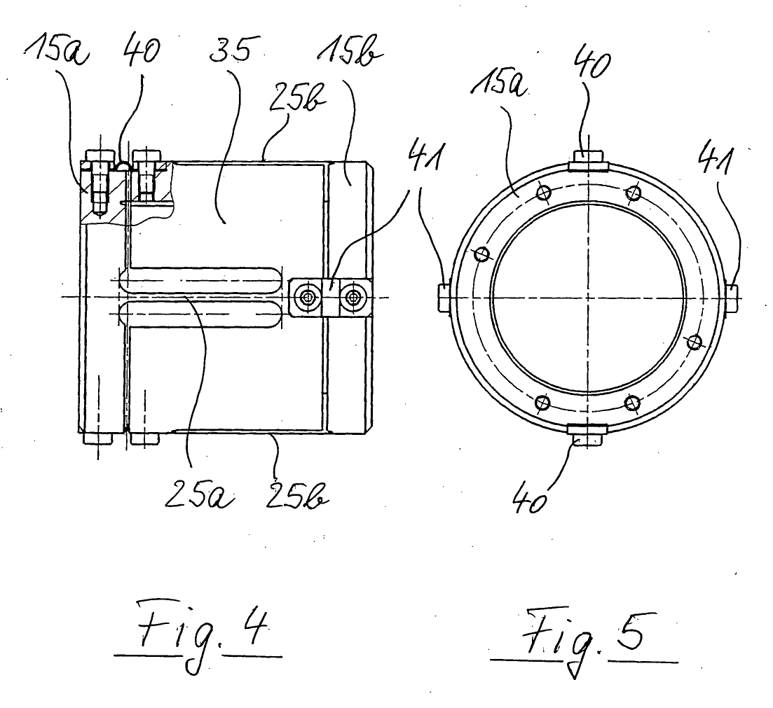

FIGS. 4 and 5 show in principle the same joint, but supplemented by spring elements 40 and 41, which connect the intermediate ring 35, while traversing the slots 36 and 37, respectively, with the connecting flange 15a and 15b. The spring elements 40 are arranged in the circumferential direction between the connecting members 25a, and the spring elements 41 are arranged between the connecting members 25b. These spring elements are flexible in the axial and radial directions due to an undulation running in the circumferential direction, but stiff in the circumferential direction. They are mounted in a positive-fit connection and play-free in matching recesses of the connecting flange and the intermediate ring and have the effect that the joint according to the invention still provides good compensation for angular and radial deviations, but remain stiff in the circumferential direction, thus exhibit a high rotational stiffness. The allocation between the rotational angle of the threaded spindle 3 and the linear adjustment path of the sled 2 is therefore further improved.

1. Arrangement for driving a machine element (2) which can move at least generally in a straight line, comprising a threaded spindle (3) which drives a nut (4) that is connected to a universal joint (5) with at least two joint halves (5a, 5b), the joint halves (5a, 5b) are connected to each other for exact positioning of the machine element (2) by connecting members (25a, 25b) that are elastic in a circumferential direction and stiff in a direction of movement of the machine element.

2. Arrangement according to claim 1, wherein the connecting members (25a, 25b) extend in a direction of movement of the machine element (2).

3. Arrangement according to claim 1, wherein the connecting members are arranged one after the other in the circumferential direction.

4. Arrangement according to claim 1, wherein the connecting members are arranged one after the other in the circumferential direction or groups of the connecting members (25a, 25b) are connected alternately with one or the other joint half (5a, 5b) and extend into a common intermediate ring (35).

5. Arrangement according to claim 1, wherein there are four connecting members offset by about 90 degrees over a circumference of the joint.

6. Arrangement according to claim 1, wherein the connecting members (25a, 25b), an intermediate ring (35) and the connecting flanges (15a, 15b) are formed by slots in a hollow cylinder.

7. Arrangement according to claim 6, wherein the slots in the hollow cylinder are filled at least partially with a damping mass.

8. Arrangement according to claim 4, wherein the joint halves (5a, 5b) are connected to an intermediate ring (35) by additional spring elements (40, 41) that are stiff in the circumferential direction and flexible in axial and radial directions.

9. Arrangement according to claim 1, wherein the threaded spindle (3) is supported on both ends so that it is fixed in an axial direction and rotatable about an axis thereof, and the spindle nut (4) is attached to the movable machine element (2) by the elastically connected joint halves (5a, 5b).

10. Arrangement according to claim 1, wherein there are four groups of connecting members (25a, 25b) offset by 90 degrees over a circumference of the joint.
